(19) United States
(12) Patent Application Publication
(10) Pub. No.: US 2019/0156340 A1
(43) Pub. Date: May 23, 2019

(54) METHOD OF DISPATCHING AN ITEM OF SECURITY INFORMATION AND ELECTRONIC DEVICE ABLE TO IMPLEMENT SUCH A METHOD

(71) Applicant: IDEMIA FRANCE, Colombes (FR)

(72) Inventors: Francis CHAMBEROT, Colombes (FR); Pierre VAURES, Colombes (FR); Antoine VILAIN, Colombes (FR)

(21) Appl. No.: 15/537,353

(22) PCT Filed: Dec. 18, 2015
(86) PCT No.: PCT/FR2015/053630

§ 371 Date: Aug. 30, 2017

(30) Foreign Application Priority Data
Dec. 18, 2014 (FR) 1462781

(51) Int. Cl. G06Q 20/40; G06Q 20/34

(52) U.S. Cl. CPC G06Q 20/4016; G06Q 20/4093; G06Q 20/405; G06Q 20/4012; G06Q 20/341

(57) ABSTRACT

Methods and devices for sending security information are disclosed. The methods may be performed by an electronic device and may include several steps or operations, such as: detecting an event encountered by the electronic device; storing security information that is representative of the event in a secure memory of the device; after the storing, starting a transaction with an external terminal; and sending the security information to the external terminal in a transaction message during the transaction.

### BACKGROUND OF THE INVENTION

The present invention lies in the general field of electronic devices suitable for co-operating with an external terminal in order to perform an operation, such as a transaction, for example.

The invention relates in particular to such electronic devices returning useful information to the external terminal in order to perform some appropriate processing.

The invention applies more particularly, but not exclusively, to smart cards (or microcircuit cards), e.g. in compliance with the ISO7816 standard. The invention relates in particular to using a smart card that operates using the Europay Mastercard Visa (EMV) protocol for returning security information to the external terminal (or reader).

In general manner, a smart card is designed to communicate with a device that is external to the card, otherwise known as a terminal or a reader. Such cards serve to perform various types of transaction, such as payment transactions or transactions for authenticating the holder, for example. By way of example, smart cards for bank applications (credit cards, debit cards, etc.) are adapted to communicate with payment terminals.

EMV is the standardized protocol that is the most used throughout the world specifically for making secure payment transactions performed by smart cards.

The EMV protocol was designed to reduce the risk of fraud during a payment transaction, in particular by making it possible both to authenticate the smart card and its holder. The authentication process relies on a combination of cryptograms (or encrypted keys) and of digital signatures, and it optionally requires a secret code to be input by the holder of the card, which code is commonly referred to as a personal identification number (PIN).

Depending on the type of card used, on the situation, or indeed on the amount in question, an EMV card may operate on-line or off-line. In on-line mode the EMV card may communicate via the reader with the corresponding issuing entity (e.g. the bank that issued the card) in order to verify that the current transaction is legitimate. In contrast, if the EMV card is used in off-line mode, it applies pre-recorded verification criteria in order to decide whether the transaction is to be authorized or refused.

Numerous security mechanisms have recently been developed in order to make the increasing use of smart cards as secure as possible, in particular cards of the EMV type.

For example, EMV smart cards have been developed that are suitable for detecting attacks of optical or other types that might be made against them by dishonest people or entities. On detecting such an attack, the smart card erases the sensitive data it contains in memory and voluntarily makes itself inoperative. If an EMV dialog is initiated with a reader, the card responds to a RESET message (RS) with an ANSWER TO RESET (ATR) response that is modified indicating that the transaction cannot take place. However little or no information is included in this ATR response, which makes it difficult at the reader end to determine why the dialog has failed.

At present, there does not exist a satisfactory mechanism enabling security information to be returned effectively from a smart card (or more generally from an electronic device) to a reader in order to enable security risks to be better evaluated, in order to identify possible attacks encountered by the smart card, or indeed in order to perform processing as a function of certain behaviors observed with respect to the card.

The possibilities of tracking behaviors of a holder of a smart (or equivalent) card or of tracking operations performed by the card are at present limited and they call for new mechanisms for returning information from the card to the reader, or indeed to a remote third party such as the issuer of the smart card, for example.

In particular, there exists a need for a solution enabling such information to be returned without significantly modifying present communications protocols (e.g. of the EMV type) that are performed collectively by electronic devices and the associated readers.

### OBJECT AND SUMMARY OF THE INVENTION

To this end, the present invention provides a sending method for sending security information, which method is performed by an electronic device and comprises the following steps:

detecting an event encountered by the electronic device;

storing security information representative of said event in a secure memory of the device;

after said storing, starting a transaction with an external terminal; and

sending the security information to the external terminal in a transaction message during said transaction.

In a particular implementation, the event detected by the electronic device comprises at least one of the following:

an anomaly encountered by the electronic device; and

an attack against the electronic device.

In a particular implementation, the event is detected by the electronic device on the basis of the current value of a counter.

In a particular implementation, the event is an anomaly or an attack, said anomaly or attack being detected by the electronic device by comparing the current value of the counter with a threshold value.

In a particular implementation, the counter represents at least one of the following:

a number of consecutive failed attempts at inputting a secret code; and

a total number of incomplete transactions performed by the electronic device.

In a particular implementation, the security information comprises the current value of said counter as stored in the secure memory.

In a particular implementation, during said detection, the electronic device detects as an event a time interval between:

said electronic device sending a response to a command from the external terminal; and

receiving a subsequent command from the external terminal.

In a particular implementation, said electronic device is configured to decide on the basis of a comparison between said time interval and a predetermined threshold value whether data representative of said time interval should be stored during the storing step.

In a particular implementation, said event satisfies at least one of the following conditions:

the event causes the electronic device to be reinitialized; and

the event comprises the electronic device executing an operation that affects a confidential code stored in a secure memory of the electronic device.

In a particular implementation, an abnormal behavior of the electronic device or an attack against said electronic device is detected if at least one condition pre-recorded in the electronic device is satisfied.

In a particular implementation, the transaction and the transaction message including the security information comply with the EMV protocol.

In a particular implementation, the sending method comprises sending referencing data to the external terminal in an AFL message, enabling the external terminal to read the security information in the secure memory of the electronic device;

the security information being sent to the external terminal in response to a read command received from the external terminal after sending the AFL message.

In a particular implementation, the sending method comprises sending referencing data to the external terminal in an ATR message, enabling it to read the security information in the secure memory of the electronic device.

In a particular implementation, the security information is sent to the external terminal as data that is not interpretable by the external terminal and in response to a GENERATE AC message received from the external terminal.

In a particular implementation, the various steps of the sending method are determined by computer program instructions.

Consequently, the invention also provides a computer program on a data (or recording) medium, the program being suitable for being performed in an electronic device such as a smart card or a computer, the program including instructions adapted to performing steps of a sending method as defined above.

The invention also provides a recording medium (or data medium) that is readable by a computer and that includes instructions of a computer program as mentioned above.

The invention also provides a processing method performed by a terminal that is external to an electronic device, said method comprising the following steps:

starting a transaction with the electronic device;

during the transaction, receiving a transaction message containing security information from the electronic device, said security information being representative of an event that has been detected by the electronic device; and

processing the security information.

In a particular implementation, the processing comprises at least one of the following:

performing risk analysis associated with said transaction on the basis of the security information; and

sending the security information to a server that is remote from the external terminal.

Correspondingly, the invention also provides an electronic device comprising:

a detector module for detecting an event encountered by the electronic device;

an obtaining module for obtaining security information representative of said event;

a storage module for storing the security information in a secure memory of the device;

an execution module suitable, after the security information has been stored, for starting a transaction with the external terminal; and

a sender module for sending the security information to the external terminal in a transaction message during said transaction.

The various implementations or variants defined above with reference to the sending method apply in analogous manner to the electronic device of the invention.

In a particular embodiment, the execution module is suitable for carrying the transaction through to its end once the security information has been sent to the external terminal.

In a particular embodiment, the electronic device is a smart card.

In a particular embodiment, the detector module comprises at least one of the following:

a first processor module suitable for detecting said event on the basis of a command received from an external entity by an interface module of the electronic device, said interface module serving to set up communication between the electronic device and said electronic entity; and

a sensor suitable for detecting an attack made against the electronic device and a second processor module suitable for detecting said event on the basis of the detected attack.

The invention also provides a terminal external to an electronic device, said terminal comprising:

an execution module suitable for starting a transaction with the electronic device;

a receiver module suitable during a transaction for receiving a transaction message from the electronic device, the transaction message containing security information representative of an event detected by the electronic device; and

a processor module for processing the security information.

In a particular embodiment, said transaction and said transaction message comply with the EMV protocol, and the terminal comprises:

an extractor module suitable, during the transaction, for extracting referencing data from an ATR message received by the electronic device, which referencing data enables the terminal to read the security information in a secure memory of the electronic device.

It should be observed that the computer programs mentioned in the present disclosure may use any programming language and be in the form of source code, object code, or code intermediate between source code and object code, such as in a partially compiled form, or in any other desirable form.

Furthermore, the recording (or data) media mentioned in the present disclosure may be any entity or device capable of storing the program. By way of example, the medium may comprise storage means, such as a read only memory (ROM), e.g. a compact disk (CD) ROM, or a microelectronic circuit ROM, or indeed magnetic recording means, e.g. a floppy disk or a hard disk.

Furthermore, the data medium may comprise a transmissible medium such as an electrical or optical signal suitable for being conveyed via an electrical or optical cable, by radio, or by other means. The program of the invention may in particular be downloaded from an Internet type network.

Alternatively, the data media may correspond to an integrated circuit in which the program is incorporated, the circuit being adapted to execute or to be used in the execution of the method in question.

### BRIEF DESCRIPTION OF THE DRAWINGS

Other characteristics and advantages of the present invention appear from the following description given with reference to the accompanying drawings which show embodiments having no limiting character. In the figures:

FIG. 1 is in the form of a flow chart showing an example of co-operation between a smart card and an external terminal in compliance with the EMV protocol;

FIG. 2 is a diagram showing the hardware architecture of smart card in accordance with a particular embodiment of the invention;

FIG. 3 is a diagram of the modules implemented by the FIG. 2 smart card;

FIG. 4 is a diagram showing the hardware architecture of a card reader in accordance with a particular embodiment of the invention, the reader being suitable for co-operating with the smart card shown in FIGS. 2 and 3;

FIG. 5 is a diagram showing the modules implemented by the FIG. 4 card reader;

FIG. 6 is a flow chart showing a sending method performed by the FIG. 2 smart card in accordance with a particular implementation of the invention;

FIG. 7 is a flow chart showing a sending method and a processing method in accordance with a first implementation of the invention;

FIG. 8 is a flow chart showing a sending method and a processing method in accordance with a second implementation of the invention; and

FIG. 9 is a flow chart showing a sending method and a processing method in accordance with a third implementation of the invention.

### DETAILED DESCRIPTION OF EMBODIMENTS

As mentioned above, the present invention lies in the general field of electronic devices suitable for co-operating with an external terminal (or reader) in order to perform an operation such as a transaction, for example.

The invention relates in particular to such electronic devices returning security information to the external terminal in order to optimize evaluation of certain security risks, in order to identify possible attacks encountered by the electronic device, or indeed in order to perform processing as a function of certain behaviors observed with respect to the electronic device.

The present invention is described below in the context of a smart card of the EMV type (e.g. in compliance with the ISO7816 standard), which card is suitable for returning security information to an external reader during an EMV transaction. Nevertheless, it should be understood that other types of protocol may be envisaged in the context of the invention.

The invention relates more particularly to an electronic device for co-operating with an external terminal (or reader) in order to perform an operation, typically a transaction (e.g. a payment). The electronic device is suitable in particular for supplying security information to the reader after starting a transaction therewith.

The concept of a “transaction” should be understood broadly herein and includes, by way of example, in the field of banking, not only a payment transaction or a transfer transaction, but also consulting a bank account on a bank terminal. The invention is described below in the context of a payment card that is to perform bank transactions. It should be understood that other types of transaction or other types of operation may be envisaged in the context of the invention.

It should also be observed that in the embodiments described below, the smart card co-operates with the reader in a contact mode. Nevertheless, the invention applies equally to circumstances in which the smart card communicates with the reader in a contactless mode.

Unless specified to the contrary, elements that are common or analogous to a plurality of figures are given the same reference numbers and present characteristics that are identical or analogous, such that these common elements are generally not described again, for reasons of simplicity.

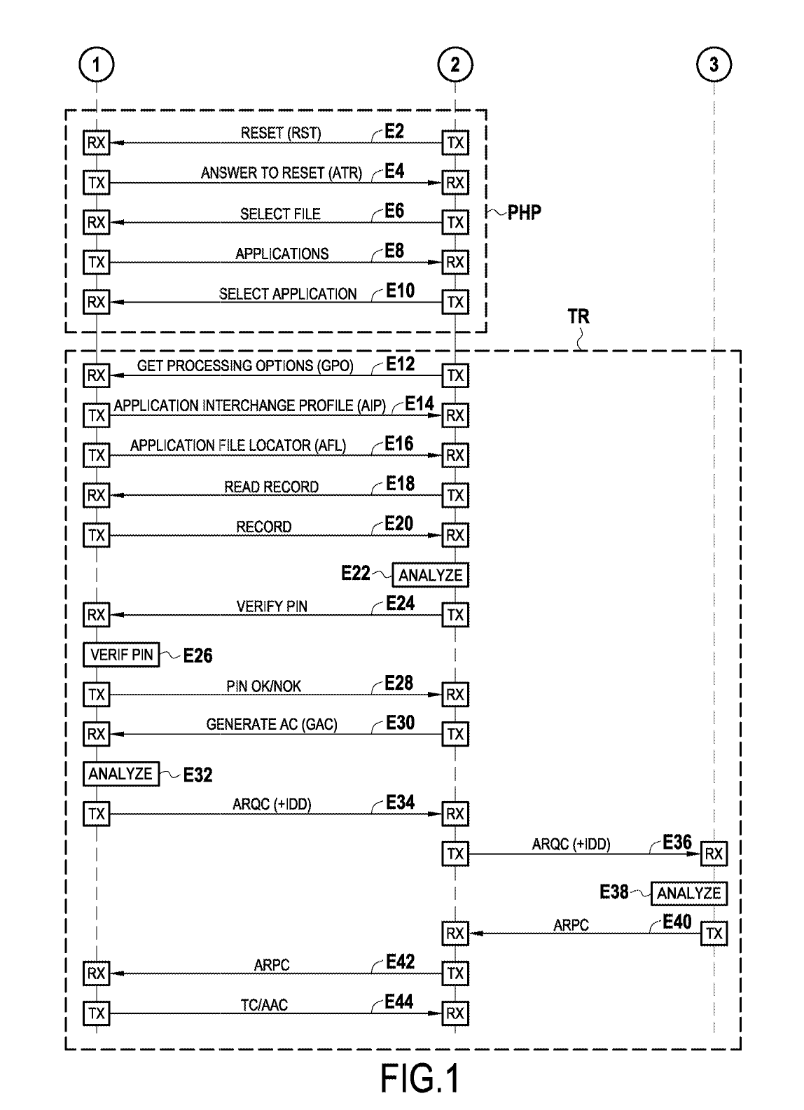

In order to facilitate understanding the invention, there follows, with reference to FIG. 1, a description of an example of a payment transaction in compliance with the EMV protocol using a smart card 1 co-operating with an external reader (or terminal) 2. The reader 2 is suitable for communicating with a bank server 3 associated with the issuer of the smart card 1. In this example, the smart card 1 is a payment card and the reader 2 is a payment terminal.

As mentioned below, the smart card 1 in this example operates in a mode involving verifying a secret code, even though it is possible to envisage variants in which the smart card 1 does not proceed with verifying the secret code (a mode without secret code verification).

An EMV payment smart card generally contains various banking applications enabling it for example to operate in a “credit card” mode or a “debit card” mode at a point of sale, or indeed to interact with an automatic teller machine (ATM).

It is assumed herein that the holder inserts the smart card 1 into the reader 2.

The EMV protocol has a preliminary stage PHP for preparing the smart card 1 and the reader 2 for the procedures to be followed in the transaction TR itself. Various messages in compliance with the EMV protocol are exchanged between the smart card 1, the reader 2, and in this example the bank server 3 during the PHP stage and then during the transaction TR.

More precisely, during the preliminary stage PHP, the reader 2 sends (E2) firstly a RESET message (RST) to the payment card 1. The payment card 1 responds (E4) using an ANSWER TO RESET (ATR) message.

Once this first dialog has taken place, the reader 2 attempts to select the appropriate application on the payment card 1. To do this, the reader 2 sends (E6) a SELECT FILE command to the card 1 in order to request of the card 1 the applications that it is capable of executing. This SELECT FILE command typically contains an application identifier (AID) parameter “1PAY.SYS.DDF01”.In response, the card 1 supplies (E8) the reader 2 with a list of the various applications that it can perform. The holder can then use the reader 2 to select the desired transaction mode, thereby causing a SELECT APPLICATION command to be sent (E10) to the card 1 together with an AID parameter for the selected application. It should be observed that there exist several variants for selecting the appropriate application in the card 1.

The reader 2 also sends (E10) a GET PROCESSING OPTIONS (GPO) command to the smart card 1 in order to identify the beginning of the transaction. Sending this GPO command marks the beginning of the EMV transaction.

During the transaction TR, the payment card 1 sends (E14) to the reader 2 a first information series such as the application interchange profile (AIP) that informs the reader 2 of the various operations to be done in order to carry out a transaction. The card 1 also sends (E16) an application file locator (AFL) message that gives the list of data available in the application in the card 1 and that the reader 2 needs to read in order to be able to perform the transaction TR. The reader 2 thus reads (E18-E20) the information specified in the AFL. To do this, the reader 2 sends (E18) one or more READ RECORD commands to the payment card 1 and in return it receives (E20) the requested information (referred to as RECORDS).

It should be observed that the steps E14 and E16 may be performed while sending a single message from the smart card 4.

By way of example, the information read (E18-E20) by the reader 2 in the card 1 comprises the expiry date of the smart card 1, the associated account number, a digital signature for authenticating the card 1, checking parameters for use subsequently in order to carry out the transaction, or indeed card data object lists (CDOLs).

Various implementations can be envisaged. In this example, the reader 2 subsequently performs (E22) an analysis step on the basis of the information supplied (E20) by the payment card 1. If the authentication associated with the payment card 1 fails, if an anomaly is detected, or indeed if too great a risk is detected, the reader 2 can refuse the transaction. It is assumed at this point that the analysis E22 is passed successfully.

The EMV protocol then continues in this example with a stage of authenticating the holder of the smart card 1 using one of the methods listed and supported by said card. The reader 2 determines the holder authentication method that is to be applied as a function of information previously received in the control parameters. This stage serves in particular to enable the payment terminal to determine whether the transaction is to be carried out in code verification mode or in no code verification mode.

In this example, where code verification mode is performed, the holder is invited to input the PIN code via the keypad that is generally provided on the reader 2. The reader 2 then sends (E24) a VERIFY request to the payment card 1 for it to verify the PIN code input by the holder. The payment card 1 then compares (E26) the PIN code input by the holder with the authentic PIN code included in its own memory and determines whether the holder is or is not authentic.

If the PIN code as input is good, the payment card 1 sends (E28) an OK message of the 0x9000 type to the terminal. Otherwise, the card sends (E28) a refused message of the 0x63Cx type to the terminal, where x is the number of PIN code attempts remaining before the card 1 blocks the current transaction (and future transactions). The description relates only to off-line verification of the PIN code, i.e. without the reader 2 calling the card issuer during the process of verifying the PIN code, even though that is also possible.

Once the holder is authenticated, the EMV protocol continues with a stage of verifying the transaction. More precisely, the reader 2 generates a GENERATE AC (GAC) command and then sends (E28) it to the card 1. This command contains various data items previously requested by the payment card 1 in the CDOL list received in step E20 by the reader 2. Typically, the GAC command contains information such as the amount of the current transaction, the currency used, the type of transaction, etc.

In response to the GAC command, the card 1 performs (E32) an analysis step involving a certain number of criterion-verification steps. The number and the nature of these verifications are not standardized in the EMV protocol and may vary depending on circumstances.

At the end of the analysis E32, the payment card 1 responds to the reader 2 by sending (E34) a cryptogram (or cryptographic certificate) that includes a message authentication code (MAC), which code is typically encrypted using a cryptographic key stored in the smart card 1. The response of the card depends in particular on the way the issuing bank has set the card 1.

In this example, the smart card 1 sends (E34) an authorization request cryptogram (ARQC) indicating that the card 1 seeks to continue the transaction on line with the bank server 3 of the card issuer. The payment card 1 may also send (E34), where appropriate, issuer discretionary data (IDD) information to the reader 2 in addition to the cryptogram.

The reader 2 thus transmits (E36) the ARQC cryptogram (and where appropriate the IDD information) to the bank server 3 that performs (E38) new analysis on the basis of the data it receives. This analysis E38 typically comprises performing a certain number of verifications in order to ensure that the transaction is valid. The reader 2 receives (E40) in response an encrypted ARPC message giving the issuer's decision. The reader 2 transmits (E42) this ARPC message to the payment card 1 in order to inform it of the decision taken by the issuer.

If the card 1 accepts the transaction, it sends (E44) a transaction accepted (TC) type cryptogram in response to the reader 2. Otherwise, the card 1 sends (E44) an AAC type cryptogram indicating that the transaction is refused.

Each of the above messages exchanged using the EMV protocol during the transaction TR, in particular between the smart card 1 and the reader 2, constitutes an example of a transaction message in the meaning of the invention.

It should be recalled at this point that the conduct of the EMV protocol as described above with reference to FIG. 1 merely constitutes a non-limiting example. Specifically, the EMV protocol makes numerous alternatives available. It is up to integrators to make the necessary choices for adapting the execution of the protocol depending on requirements (method of authenticating the holder, on-line or off-line transaction, etc.).

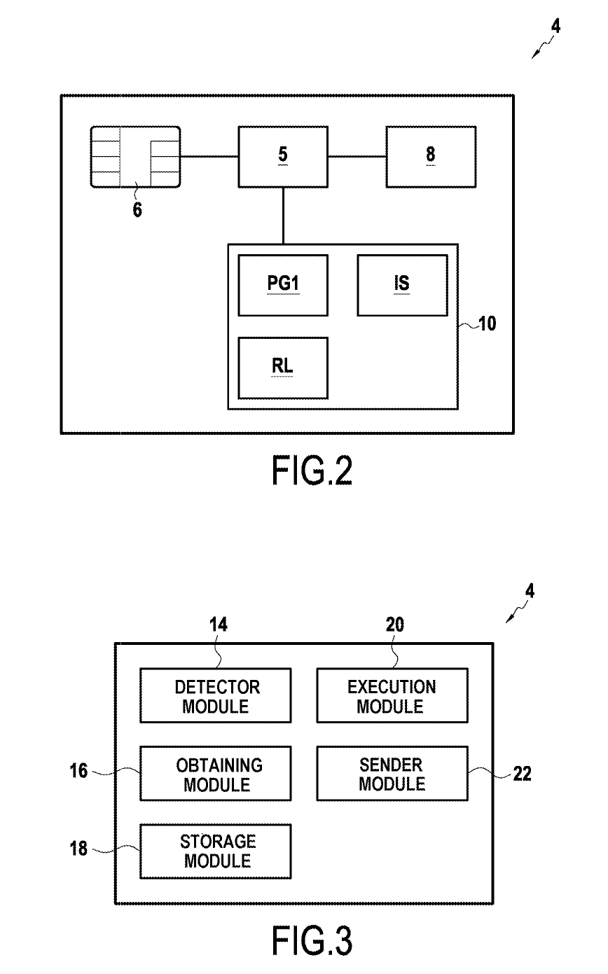

FIG. 2 is a diagrammatic view of the hardware architecture of a smart card 4 in accordance with a particular embodiment of the invention. In this example, the card 4 is an EMV card in accordance with the IS07816 standard.

More particularly, in this example, the card comprises a microprocessor 5 coupled to external contacts 6 (input/output ports), a rewritable volatile memory (of the random access memory (RAM) type) 8, and a rewritable non-volatile memory 10 (e.g. of the flash type). The card 4 may also include a read only memory (ROM), not shown in this example.

It is assumed that the memory 10 is secure, making use of a conventional security mechanism well known to the person skilled in the art and therefore not described herein.

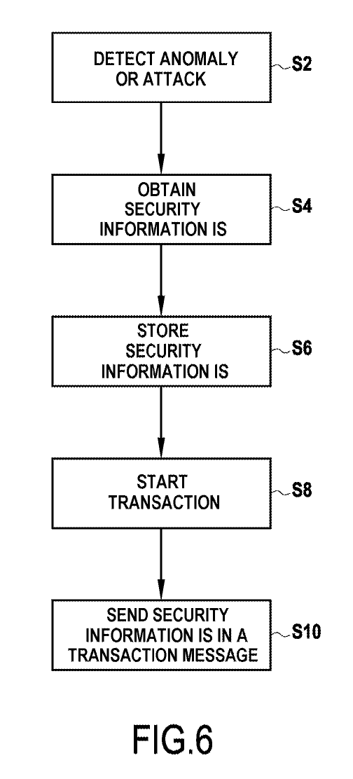

In this example, the memory 10 constitutes a data medium in accordance with an embodiment of the invention that is readable by the smart card 4 and that stores a computer program PG1 in accordance with an embodiment of the invention. The program PG1 includes instructions for executing steps of a method of sending security information IS that may also be stored in the memory 10, in accordance with an implementation of the invention. Implementations of the method are shown in FIGS. 6 to 9, which are described below.

In the presently-described example, the memory 10 of the smart card 4 also includes at least one predefined rule RL that is described below.

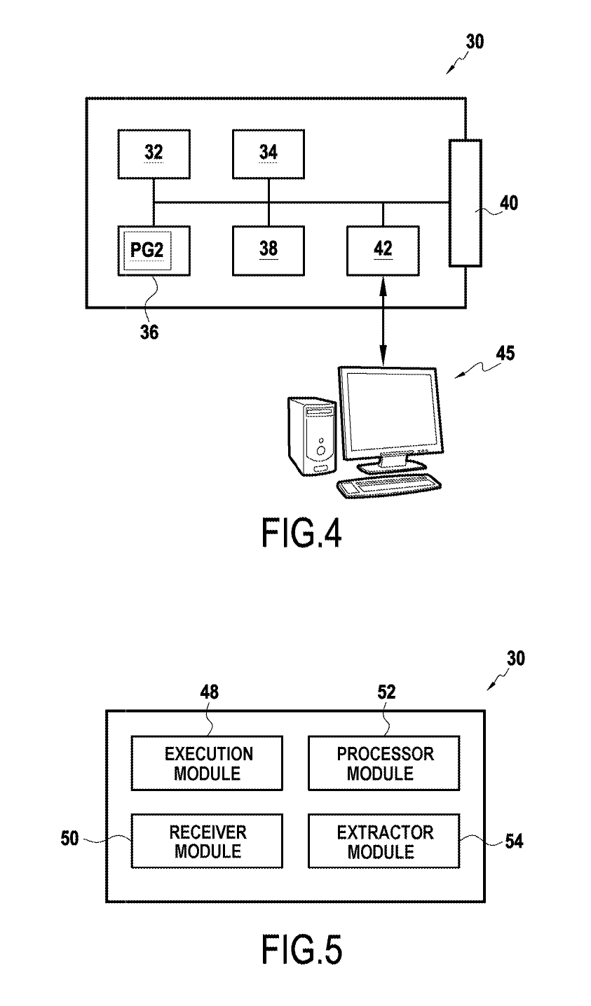

In this example, the external contacts 6 constitute an interface module enabling the smart card 4 (and more particularly the microprocessor 5) to set up communication, e.g. via contacts in this example, with an external entity such as the terminal 30 as described below with reference to FIG. 4. It can be understood that other types of interface module could equally well be envisaged, such as an interface module enabling contactless communication to be set up (e.g. including a radiofrequency (RF) antenna) between the smart card and an external terminal.

In a particular example, the smart card 4 includes at least one sensor (not shown in the figures) suitable for detecting an attack made against the electronic device. By way of example, the sensor may be an optical sensor and/or an electromagnetic sensor. By way of example, the sensor serves to detect an attack of optical type (e.g. by laser) and/or of electromagnetic type.

FIG. 3 is a diagram of modules that may be implemented by the microprocessor 5 executing the program PG1, namely: a detector module 14 for detecting an event EVT; an obtaining module 16 for obtaining security information IS; a storage module 18 for storing such security information; an execution module 20 serving in particular to start an EMV transaction; and a sender module 22 suitable for sending the security information during an EMV transaction.

In a particular example, the detector module 14 comprises at least one of the following:

a first processor module (not shown) suitable for detecting the event EVT on the basis of a command (e.g. of the APDU type) received from an external entity (such as the terminal 30 shown in FIG. 4) by the interface module 6 of the smart card 4; and

a sensor (not shown) suitable for detecting an attack occurring against the smart card 4, and a second processor module (not shown) suitable for detecting the event EVT on the basis of the detected attack.

By way of example, the command (of APDU or other type) is received by the smart card 4 during a given transaction (e.g. of EMV type) with an external terminal, the command being received from the external terminal via the external contacts 6.

Furthermore, as explained above, the above-mentioned sensor may for example be an optical and/or electromagnetic sensor suitable for detecting an optical and/or magnetic attack encountered by the smart card 4, which attack may for example be made by a fraudulent person or device.

FIG. 4 is a diagram showing the hardware architecture of an external terminal 30 (specifically a card reader) in a particular embodiment of the invention. In this example, the card reader 30 is suitable for co-operating with the smart card 4 by using the EMV protocol.

More particularly, the card reader 30 comprises a microprocessor 32, a ROM 34, a rewritable non-volatile memory 36, a man/machine interface 38 enabling a user to interact with the reader 30, a connector 40 compatible with the external contacts of the smart card 4, and a communication interface 42 enabling the reader 30 to communicate with an external entity such as a remote server 45 in this specific example. The remote sever 45 in this example is associated with the issuer of the smart card 4 (typically a bank).

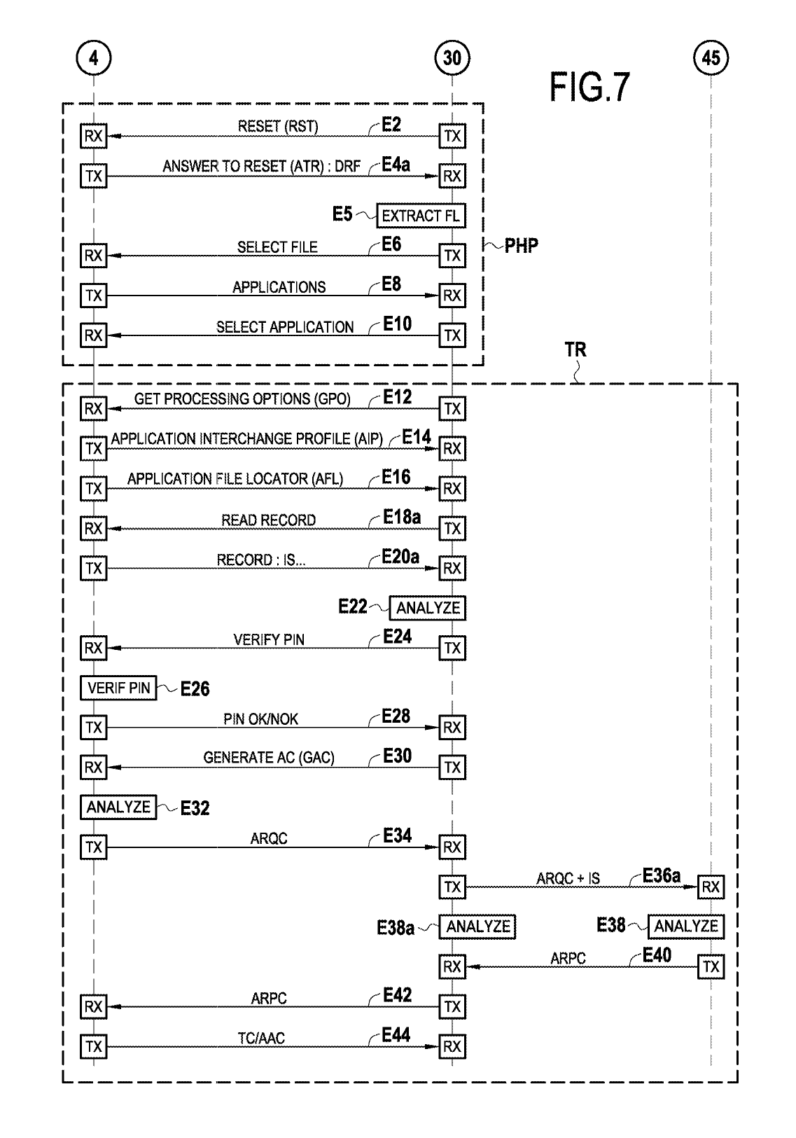

In this example, the memory 36 constitutes a data medium in accordance with an embodiment of the invention that is readable by the reader 30 and that stores a computer program PG2 in accordance with an embodiment of the invention. The program PG2 includes instructions for executing steps of a processing method in accordance with an implementation of the invention. Implementations of this method are shown below with reference to FIGS. 7 to 9.

FIG. 5 is a diagram of modules that may be implemented by the microprocessor 32 of the reader 30 executing the program PG2, namely: an execution module 48 serving to start a transaction TR with the smart card 4 (sending a GPO message), a receiver module 50 suitable for receiving security information IS contained in a transaction message coming from the smart card 4, a processor module 52 suitable for processing on the basis of the received security information IS, and optionally an extractor module 54 suitable for extracting reference data DRF from a message received from the smart card 4, as described in greater detail below.

A particular implementation of the invention is described below with reference to FIG. 6. More precisely, the smart card 4 performs a sending method by executing the program PG1.

Initially, the smart card 4 detects (S2) an event EVT. By way of example, this event may be representative of an anomaly encountered by the smart card 4 or of an attack against the smart card 4.

In the presently-described example, the event EVT is detected (S2) by the detector module 14 shown in FIG. 3.

In one particular situation, the event EVT satisfies at least one of the following conditions:

the event EVT causes the smart card 4 to be reinitialized; and

the event EVT comprises the smart card 4 executing a command or an operation that affects a (secret code) PIN code stored in a secure memory of the smart card 4. Examples of such a command include the commands CHANGE PIN and UNBLOCK PIN.

More generally, the event EVT as detected (S2) by the smart card 4 may be any event encountered by the smart card 4 that it judges to be worthy of interest, which judgment may optionally be based on at least one condition pre-stored in a rule RL.

The event EVT as detected in this way by the smart card 4 may correspond to one or more events.

By way of example, the event EVT may be detected during an interaction with an external reader or terminal (e.g. during a transaction). In a particular example, a command (e.g. of APDU type) from an external terminal is received by the smart card 4 via the external contacts 6. The detector module 14 (or more particularly a first processor module included in the detector module 14) then detects the event EVT on the basis of the received command, or possibly on the basis of processing performed by the first processor module on the basis of said command.

Alternatively, the event EVT may be an attack (of optical and/or electromagnetic type) against the smart card 4, which attack is detected by the detector module 14, in particular by using a sensor suitable for detecting the attack and a second processor module suitable for detecting the event EVT on the basis of the detected attack. Under such circumstances, the attack is therefore not detected by using the external contacts 6 (or any other interface module of the smart card suitable for communicating with an external terminal), but rather by means of a suitable sensor of the smart card 4, as explained above.

On detecting the event EVT, the smart card 4 obtains (S4) security information IS representative of the event. To do this, the smart card 4 may for example apply a rule RL contained in memory 10, this rule specifying information IS that is to be generated for at least one given event.

In the presently-described example, the security information IS is obtained S4 by the obtaining module 16 shown in FIG. 3.

Thereafter, the smart card 4 stores (S6) this security information IS in memory 10. By way of example, the smart card 4 creates a file (referred to herein as a LOG file) containing each item of security information IS that has been obtained.

In the presently-described example, storage S6 is performed by the storage module 18 shown in FIG. 3.

It is assumed that after storage S6 a transaction of EMV type is started (S8) between the smart card 4 and the external reader 30. This typically occurs when the card 4 is inserted by the user in the reader 30 in order to perform a banking operation (consulting an account, payment, transfer, . . . ).

As mentioned above, it is the EMV protocol that is used in this example. Consequently, the smart card 4 and the reader 30 together perform the preliminary stage PHP (exchanging the RST and ATR messages, etc.) as described above with reference to FIG. 1. As already mentioned, the smart card 4 receiving the GPO message from the reader 30 then marks the beginning S8 of the EMV transaction.

In the presently-described example, it is the execution module 20 shown in FIG. 3 that performs the preliminary stage PHP and that proceeds to the start S8 of the transaction TR (receiving the GPO) with the external reader 30.

In accordance with the invention, the smart card 4 sends (S10) the security information IS to the reader 30 in a transaction message during the transaction TR. Various EMV transaction messages may be used for conveying the security information IS to the reader 30, as explained in greater detail below with reference to FIGS. 7 to 9.

In the presently-described example, the security information IS is sent S10 by the sender module 22 shown in FIG. 3.

In a particular implementation, it is the smart card 4 that takes a decision whether or not to send (S10) security information IS stored in memory in the card 4 to the reader 30 during the transaction, with this decision being taken in application of a predefined rule RL (stored in memory 10) defining at least one pre-recorded condition. The smart card 4 decides to send security information IS only if the pre-recorded condition associated with the information IS is satisfied.

In a particular example, the smart card 4 is not capable of continuing the transaction TR with the reader 30 once the security information IS has been sent S10, e.g. because of an attack or some other anomaly that has been encountered by the card. In a variant, the smart card is suitable for continuing the transaction TR normally using the EMV protocol once the security information IS has been sent (S10) to the reader 30.

As mentioned above, the nature of the event EVT detected in S2 by the smart card 4 may vary depending on circumstances, the same applies to the security information IS that may be returned to the terminal 30.

In a particular example, the event EVT is detected (S2) by the smart card 4 on the basis of the current value of a counter stored in the smart card 4. By way of transaction, this counter represents a consecutive number of failed attempts at inputting a secret code. The secret code may be a PIN code to be input by the user via the card reader 30 co-operating with the smart card 4 in order to authenticate the user during a transaction. By way of example, the smart card 4 is configured to detect an anomaly (as an event EVT) by comparing the current value of the counter of failed attempts at inputting a secret code with a threshold value. For example, if the current value reaches a predefined threshold value, then the smart card 4 detects that as an event EVT. In a particular example, the smart card 4 is configured to store the current value of said counter.

In a particular example, the event EVT is a transaction error detected by the smart card 4 during a transaction. By way of example, the smart card 4 is suitable for detecting a transaction error on the basis of at least one item of transaction information received and stored in the smart card 4 during a transaction (e.g. of the EMV type). By way of example, the smart card 4 is configured to return (S10) the transaction information to the terminal 30.

In a particular example, the smart card 4 detects as an event EVT the fact that a counter stored in the smart card 4 exceeds a predetermined threshold value. By way of example, the counter represents a total number of incomplete transactions performed by the smart card 4. The security information IS as sent (S10) by the smart card 4 to the terminal 30 may include said counter of the total number of incomplete transactions. In a particular example, the counter has a plurality of components, and the counter can indicate a type of attack that has been carried out against the smart card, or indeed the type of failure that the smart card presents.

In a particular example, the smart card detects, as an event EVT, a time interval between (1) sending a response by the card 4 to a command from the external terminal 30; and (2) receiving a subsequent command from the external terminal 30. The smart card 4 is then configured to store and then send as security information IS, data representative of said time interval, during steps S6 and S10 respectively. In a particular example, the smart card 4 decides whether it needs to store data in step S6 that is representative of such a time interval, on the basis of making a comparison between said detected time interval and a predetermined threshold value.

As described above, various types of security information IS can be envisaged in the context of the invention.

In a particular example, the security information IS comprises data representing the current value of a counter stored in the smart card 4. This counter may comprise at least one of the above-described counts. In particular, the counter may represent at least one of the following:

a consecutive number of failed attempts at inputting a secret code; and

a total number of incomplete transactions performed by the smart card 4.

In a particular example, the security information IS includes said current value itself or else a parameter indicating that the current value of the counter has reached a predefined threshold value.

In a particular example, the security data IS is representative of a transaction error detected and stored by the smart card 4 during a transaction.

The return of the security information IS during a transaction enables the reader 30, and optionally the bank server 45, to be informed that an event has occurred, e.g. relating to an attack made against the smart card 4, relating to a security risk associated with the smart card 4 and/or its holder, or indeed relating to behavior previously observed by the smart card 4.

On the basis of the received security information IS, the reader 30 is capable of performing special processing, such as for example evaluating a risk associated with the current transaction or transmitting the security information IS to the remote server 45.

Various implementations of the sending method performed by the smart card 4 and the processing method performed by the reader 30 are described below with reference to FIGS. 7 to 9.

In the implementations shown in FIGS. 7 to 9, it is assumed that the smart card 4 has already performed the steps S2 to S8 when it receives (E2) an RST message from the reader 30. As mentioned below, it is nevertheless possible to envisage variants in which at least one of the steps S2 to S6 is performed by the smart card 4 after it has received the RST message, or indeed after beginning the transaction S8.

In a first implementation, shown in FIG. 7, the smart card 4 and the reader 30 co-operate using the EMV protocol.

Compared with the example described with reference to FIG. 1, the conduct of the EMV protocol differs in this example in that the RST message sent by the smart card 4 is used to enable the reader 30 to read the security information IS in the memory of the smart card 4 during the transaction TR.

In this example, the reader receives (E2) an RST message from the reader 30. In response, the smart card 4 sends (E4a) a modified ATR message, which message contains reference data DRF enabling the reader 30 to read the security information IS in the secure memory 10 of the smart card 4.

During a step E5, the reader 30 extracts the reference data DRF from the ATR message.

The steps E6 to E16 are performed as described above with reference to FIG. 1.

In response to the EFL message sent (E16) by the smart card 4, the reader 30 reads (E18-E20a) in the memory of the smart card 4 information as specified in the AFL message. In this first implementation, the reader 30 also reads the security information IS stored in the memory 10 of the smart card 4 by using the reference data DRF. This data DRF may for example specify a memory address where the security information IS is stored.

Thereafter, the reader 30 performs appropriate processing on the basis of the received security information IS.

In this example, the steps E24 to E34 are performed as described above with reference to FIG. 1. The reader 30 then sends (E36a) the message ARQC (as previously received from the smart card 4 in step E34) together with the security information IS to the remote server 45.

The remote server 45 (or another associated terminal) then performs analysis (E38) on the received information, if necessary including the security information IS.

The reader 30 may also perform analysis (E38a) on the basis of the security information IS. Following this analysis, the reader may, where necessary, adapt the processing of the current transaction TR, e.g. in order to reject the transaction or to perform additional security mechanisms.

The steps E40 to E44 are performed as described above with reference to FIG. 1.

In a variant of this first implementation, the smart card 30 transmits the reference data DRF not in the ATR message (E4) but in the APPLICATIONS message in step E8.

It should be observed that in this first implementation, the reader 30 is modified to be capable of recognizing the reference data DRF included in the ATR message (or in the APPLICATIONS message) as such, and to use it in order to recover the security information IS from the smart card 4.

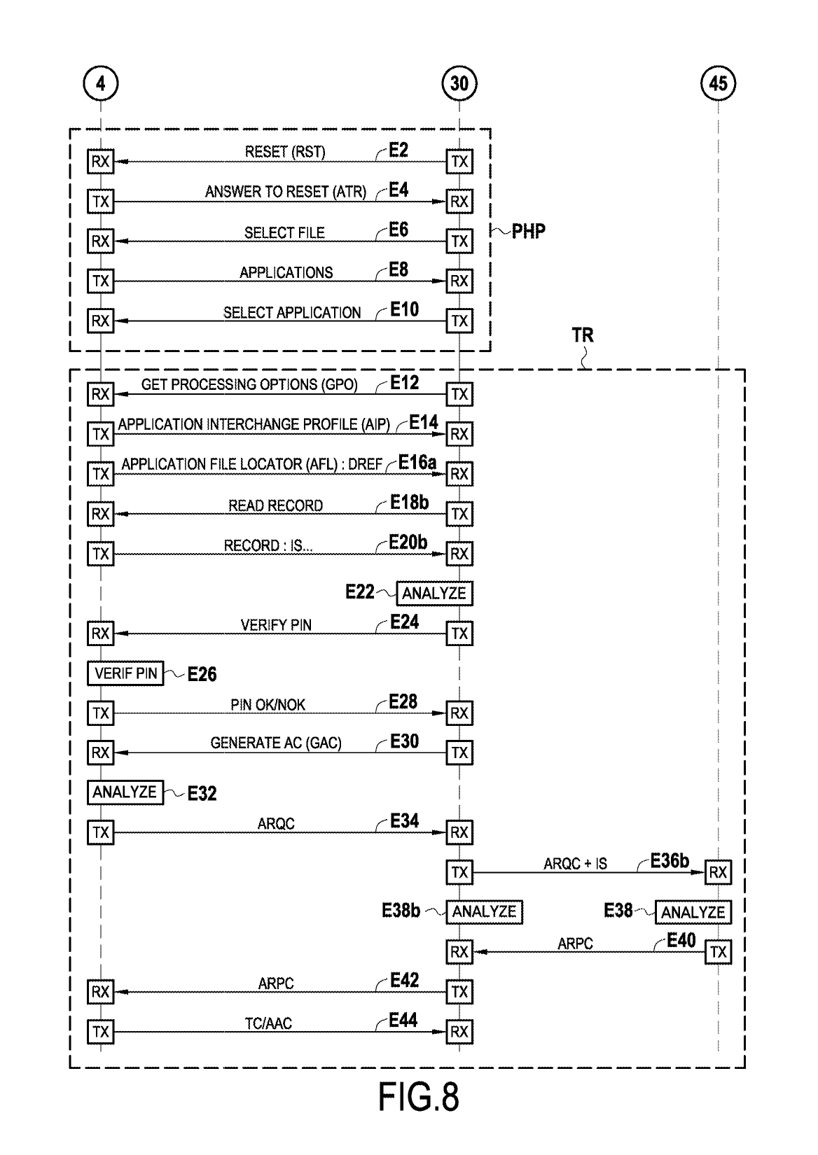

In a second implementation shown in FIG. 8, the smart card 4 and the reader 30 co-operate, likewise using the EMV protocol.

In this example, the conduct of the EMV protocol differs from that of the first implementation described with reference to FIG. 7 in that the smart card 4 transmits (E16a) the reference data DRF directly in the AFL transaction message.

Thereafter, the reader 30 reads the necessary information in the smart card 4, i.e. the information specified in the AFL. To do this, the reader 30 sends (E18b) one or more read commands to the smart card 4, to which it responds by supplying (E20b) the requested information to the reader 30. In particular, the reader 30 reads the security information IS stored in the memory 10 of the smart card 4 by using the reference data DRF.

The reader 30 transmits (E36b) the security information IS to the remote server 45 and/or performs analysis (E38b) on the basis of the security information IS in analogous manner to the above-described steps E36a and E38a, respectively.

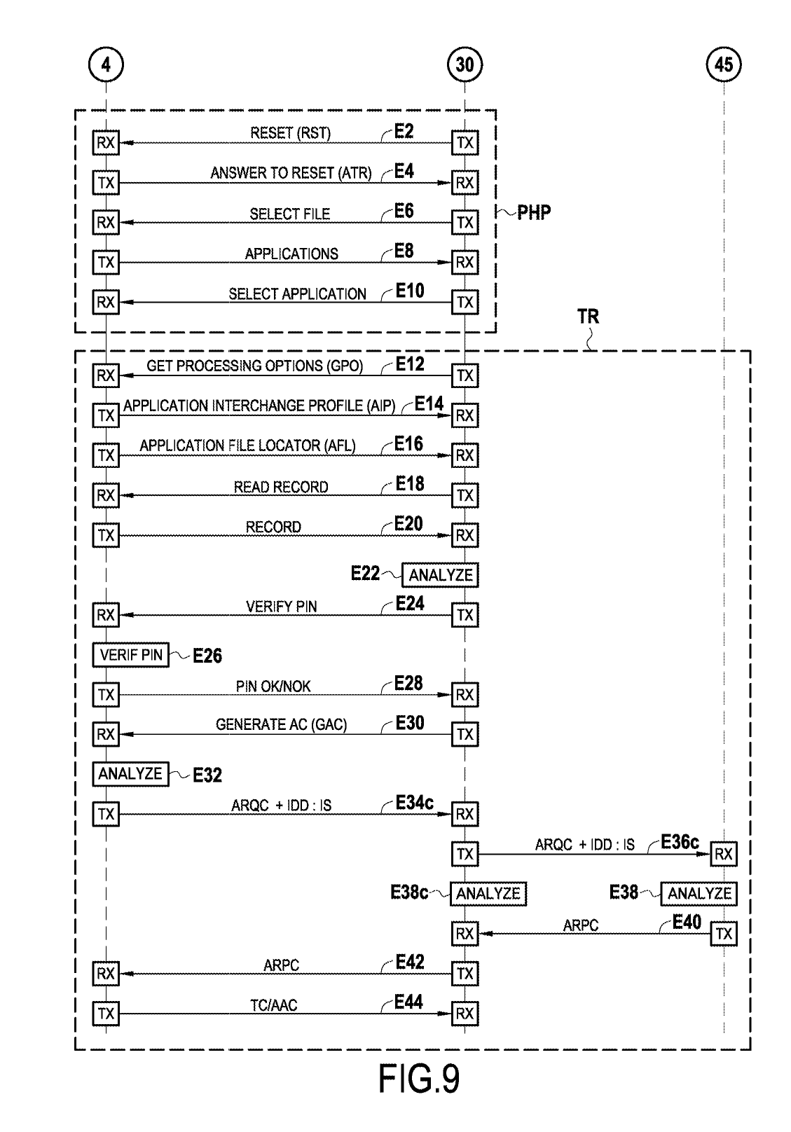

In a third implementation shown in FIG. 9, the smart card 4 and the reader 30 co-operate, likewise using the EMV protocol.

In this example, the conduct of the EMV protocol differs from that of the first and second implementations described with reference to FIGS. 7 and 8 in that the smart card 4, after the analysis E32, transmits (E34c) the security information IS to the reader 30 as issuer discretionary data (IDD). This IDD (like all IDD) cannot be interpreted by the reader 30, which does no more than relay it (E36c) to the remote server 45.

This third implementation takes advantage of the possibility made available by the EMV protocol to supply information as IDD to the reader and then to the remote server.

Analysis can then be performed in the remote server 45 on the basis of the received information, including the security information IS.

In this third implementation, the reader 30 also performs analysis (E38c) on the basis of the security information IS in a manner analogous to the above-mentioned analysis E38a or E38b.

It should be observed that in the second and third implementations as described above with reference to FIGS. 8 and 9, the reader 30 performs the processing method of the invention without there being any need to modify the EMV protocol. Specifically, the AFL transaction message or the IDD information is used for transmitting the security information IS to the reader 30.

Furthermore, in the first and second implementations described above with reference to FIGS. 7 and 8, the reader 30 sends a read command to the smart card 4 indicating that the reader 30 seeks to access the security information 30. In contrast, in the third implementation, the reader 30 does not request the smart card 4 to send the security information IS, and forwards it as IDD to the remote server 45, as mentioned above.

In a particular implementation, at least one step selected from the detection step S2, the step S4 of obtaining the security information IS, and the step S6 of storing the security information IS is performed by the smart card 4 during the preliminary stage PHP (i.e. after the card has received the RST message coming from the reader 30), or even during the current transaction TR (i.e. after the card has received the GPO message coming from the reader 30).

In one particular situation, the smart card 4 selects the method for transmitting the security information IS from among a plurality of available methods (e.g. from at least two of the above-described methods) as a function of the moment at which the smart card 4 detects that security information IS is to be transmitted to the reader. By way of example, the sending method is selected by using at least one rule RL pre-recorded in memory in the smart card 4.

In a particular example, the smart card 4, at an instant T1, detects that it holds security information IS for transmission, and then transmits the security information IS as follows:

if T1 is before the smart card 4 sends the ATR, then the card transmits the security information IS to the reader 30 by performing the first implementation shown in FIG. 7 (using the ATR followed by sending the security information IS during the transaction TR);

if T1 is after sending the ATR but before sending the APPLICATIONS message, the card 4 supplies the reference data DRF to the reader 30 by using the APPLICATIONS message, and subsequently sends the security information IS during the transaction TR (variant of the first implementation);

if T1 is after sending the APPLICATIONS message but before receiving the GPO, the card 4 sends the reference data DRF in the AFL message and subsequently sends the security information IS during the transaction TR (second implementation shown in FIG. 8); and

if T1 is after receiving the GPO but before receiving the GAC, the card 4 sends the security information IS to the reader 30 as IDD in response to the GAC (third implementation shown in FIG. 9).

The present invention makes it possible advantageously to return security information effectively from the smart card (or more generally from an electronic device) to an external reader (or terminal) in order to enable appropriate processing to be performed by the reader, and where appropriate, by a third party such as the issuer of the smart card, for example.

The return of such security information makes it possible in particular to evaluate security risks associated with the smart card and/or the current transaction (or even an earlier transaction), to identify potential attacks encountered in the past by the smart card, or indeed to perform processing as a function of certain behavior that has been observed by the card in the past.

For example, if a command seeking to modify the card's PIN code has been performed by the smart card or if the smart card has reinitialized as a result of a given event, then the invention makes provision under particular circumstances to store security information in the smart card that is representative of this event and to transfer said information from the smart card to the reader in order subsequently to inform the issuer of the smart card. The issuer, typically the bank that issues the card, can thus analyze the events encountered by the card and, where necessary, can take the necessary measures such as for example contacting the proprietor of the card, blocking the card, or indeed refusing the current transaction.

The invention provides a mechanism that is flexible and effective for analyzing risks and/or behavior on the basis of events detected by the smart card.

The invention is advantageous in that it makes it possible to return security information to the reader, or indeed to the distant server, without it being necessary to modify the general conduct of a protocol of the EMV type, for example.

A person skilled in the art will understand that the above-described implementations and variants are merely non-limiting examples of how the invention can be performed. In particular, the person skilled in the art can envisage any combination of the variants and implementations described above in order to satisfy any particular need.

1. A method for sending security information, wherein the method is performed by an electronic device, the method comprising:
detecting an event encountered by the electronic device;
storing security information representative of said event in a secure memory of the electronic device;
after said storing, starting a transaction with an external terminal; and
sending the security information to the external terminal in a transaction message during said transaction.

2. The method according to claim 1, wherein the event encountered by the electronic device comprises at least one of the following:
an anomaly encountered by the electronic device; and
an attack against the electronic device.

3. The method according to claim 1, wherein the event is detected by the electronic device on the basis of a current value of a counter.

4. The method according to claim 3, wherein the event is an anomaly or an attack detected by the electronic device by comparing the current value of the counter with a threshold value.

5. The method according to claim 3, wherein the counter represents at least one of the following:
a number of consecutive failed attempts at inputting a secret code; and
a total number of incomplete transactions performed by the electronic device.

6. The method according to claim 3, wherein the security information comprises the current value of said counter as stored in the secure memory.

7. The method according to claim 1, wherein, during said detecting, the electronic device detects as the event a time interval between:
said electronic device sending a response to a command from the external terminal; and
receiving a subsequent command from the external terminal.

8. The method according to claim 7, wherein said electronic device is configured to decide on the basis of a comparison between said time interval and a predetermined threshold value whether data representative of said time interval should be stored during the storing.

9. The method according to claim 1, wherein said event satisfies at least one of the following conditions:
the event causes the electronic device to be reinitialized; and
the event comprises the electronic device executing an operation that affects a confidential code stored in the secure memory of the electronic device.

10. The method according to claim 1, wherein the detecting comprises:
detecting an abnormal behavior of the electronic device or an attack against said electronic device if at least one condition pre-recorded in the electronic device is satisfied.

11. The method according to claim 1, wherein the transaction and the transaction message including the security information comply with the Europay Mastercard Visa (EMV) protocol.

12. The method according to claim 11, further comprising:
sending referencing data to the external terminal in an application file locator (AFL) message, enabling the external terminal to read the security information in the secure memory of the electronic device;
wherein the security information is sent to the external terminal in response to a read command received from the external after sending the AFL message.

12. (canceled)

12. (canceled)

13. (canceled)

14. A non-transitory data medium readable by a processor and storing a computer program including instructions that, when executed by the processor, perform operations comprising:
detecting an event encountered by an electronic device;
storing security information representative of the event in a secure memory of the electronic device;
after the storing, starting a transaction with an external terminal; and
sending the security information to the external terminal in a transaction message during the transaction.

15. A processing method performed by a terminal that is external to an electronic device, said method comprising:
starting a transaction with the electronic device;
during the transaction, receiving a transaction message containing security information from the electronic device, said security information being representative of an event that has been detected by the electronic device; and
processing the security information.

16. The processing method according to claim 15, wherein the processing comprises at least one of the following:
performing risk analysis associated with said transaction on the basis of the security information; and
sending the security information to a server that is remote from the external terminal.

17. An electronic device comprising:
a detector module that detects an event encountered by the electronic device;
an obtaining module that obtains security information representative of said event;
a storage module that stores the security information in a secure memory of the electronic device;
an execution module that, after the security information has been stored, starts a transaction with an external terminal; and
a sender module that sends the security information to the external terminal in a transaction message during said transaction.

18. The electronic device according to claim 17, wherein the execution module carries through the transaction to its end once the security information has been sent to the external terminal.

19. The electronic device according to claim 17, wherein the electronic device is a smart card.

20. The electronic device according to claim 17, wherein the detector module comprises at least one of the following:
a first processor module that detects said event on the basis of a command received from an external entity by an interface module of the electronic device, said interface module serving to set up communication between the electronic device and said external entity;
a sensor configured to detect an attack made against the electronic device; and
a second processor module that detects said event on the basis of the detected attack.

21. A terminal external to an electronic device, said terminal comprising:
an execution module that starts a transaction with the electronic device;
a receiver module that, during the transaction, receives a transaction message from the electronic device, the transaction message containing security information representative of an event detected by the electronic device; and
a processor module that processes the security information.

22. The terminal according to claim 21, wherein said transaction and said transaction message comply with the Europay Mastercard Visa (EMV protocol, and the terminal comprises:
an extractor module that, during the transaction extracts referencing data from an Answer to Reset (ATR) message received by the electronic device, which referencing data enables the terminal to read the security information in a secure memory of the electronic device.

23. The method according to claim 11, further comprising:
sending referencing data to the external terminal in an Answer to Reset (ATR) message, enabling the external terminal to read the security information in the secure memory of the electronic device.

24. The method according to claim 11, wherein the security information is sent to the external terminal as data that is not interpretable by the external terminal and in response to a GENERATE AC message received from the external terminal.
